(19) United States
(12) Patent Application Publication
(10) Pub. No.: US 2006/0202632 A1
(43) Pub. Date: Sep. 14, 2006

(54) Organic electroluminescent device, driving method thereof and electronic apparatus

(75) Inventor: Hiroyuki Hara, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 11/354,030

(22) Filed: Feb. 15, 2006

(30) Foreign Application Priority Data
Mar. 10, 2005 (JP) 2005-067187

(51) Int. Cl. G09G 3/10

(52) U.S. Cl. 315/169.3

(57) ABSTRACT

An organic electroluminescent device, comprises: a plurality of scan lines; a plurality of data lines extending in a direction orthogonal to the scan lines; a light-emitting element arranged at each intersection of the scan lines and the data lines; and a drive device dividing one frame into a plurality of subframes in accordance with grayscale levels represented by an image signal supplied to the data lines, controlling light emission of the light-emitting element using the subframe to set a unit, and driving the scan lines non-progressively; the drive device driving the scan lines non-progressively so that selection timing of each subframe for each scan line has no periodicity.

### BACKGROUND

1. Technical Field

The present invention relates to an organic electroluminescent (EL) device, a method for driving the organic EL device, and an electronic apparatus.

2. Related Art

An organic EL device having an organic EL element as a light-emitting element that requires no backlight has been drawing attention recently. This organic EL element is made up of a pair of opposing electrodes and an organic EL layer, i.e. a light-emitting element, provided between the electrodes. The organic EL device that provides a full-color display includes a light-emitting element having a range of emission wavelengths for red, green and blue. As a voltage is applied to between the pair of electrodes, injected electrons and holes recombine in the light-emitting element, thereby the element emits light. The light-emitting element included in this organic EL device is formed of a thin film whose thickness is typically less than 1 micrometer. In addition, the device does not require a backlight used in conventional liquid crystal displays, since the light-emitting element provides light. Therefore, the device has an advantage in that it can be made extremely thin.

The organic EL device includes a plurality of scan lines, a plurality of data lines extending in a direction orthogonal to the scan lines, a plurality of power lines extending in parallel with the data lines and coupled to one of the pair of electrodes, and a switching element coupled to the lines. The light-emitting element is arranged at each intersection of the scan lines and the data lines in a matrix. If any of the scan lines is selected, the switching element coupled to the selected scan line is turned on. Accordingly, a current based on an image signal supplied from the data line via this switching element flows from the power line to the light-emitting element, thereby the element emits light. By driving the scan lines sequentially and supplying image signals to the data lines, the organic EL display provides an image based on the image signals.

Methods for driving this organic EL device can be broadly classified into analog driving and digital driving. The analog driving method provides the data lines with analog signals to represent grayscale. The digital driving method provides the data lines with digital signals, divides one frame into a plurality of subframes and controls light emission of the subframes with the digital signals to represent grayscale. Since the digital driving method requires an increasing number of subframes to raise grayscale levels, the operating frequency of a peripheral drive device significantly increases as the grayscale levels increase.

A non-progressive method (interlaced driving) has been developed to raise grayscale levels without increasing the operating frequency of a peripheral circuit. JP-A-2001-166730 is an example of related art. This non-progressive method interlaces scan lines in a predetermined manner, not driving every scan line sequentially.

The non-progressive method, however, may involve flickering depending on images displayed on the organic EL device, since the periodicity of interlaced scan lines creates periodicity in the emission timing of the light-emitting element.

### SUMMARY

An advantage of the present invention is to provide an organic EL device that is capable of preventing flickering attributed to periodicity in selecting scan lines to display quality images, a method for driving the organic EL device, and an electronic apparatus including the organic EL device.

An organic EL device according to an aspect of the invention includes: a plurality of scan lines; a plurality of data lines extending in a direction orthogonal to the scan lines; a light-emitting element arranged at each intersection of the scan lines and the data lines; and a drive device dividing one frame into a plurality of subframes in accordance with grayscale levels represented by an image signal supplied to the data lines, controlling light emission of the light-emitting element using the subframe to set a unit, and driving the scan lines non-progressively; and the drive device drives the scan lines non-progressively so that selection timing of each subframe for each scan line has no periodicity.

With this structure, the scan lines are driven non-progressively so that selection timing of each subframe for each scan line has no periodicity. It is therefore possible to prevent flickering attributed to periodicity in selecting the scan lines and display quality images as a result.

In the organic EL device according to the present aspect, it is preferable that the drive device drive the scan lines non-progressively so that selection timing of each subframe for each scan line has no periodicity at least partly in one frame.

Non-progressive driving does not always cause flickering, but causes flickering depending on displayed images. Therefore, for example, it is possible to apply driving to prevent flickering to a central area of an image where flickering is likely and to apply driving according to related art to other areas in a flexible manner.

In the organic EL device according to the present aspect, it is preferable that the drive device include a table to make selection timing of each subframe for each scan line have no periodicity and driving the scan lines in accordance with the table.

Since this structure makes selection timing of each subframe for each scan line have no periodicity in accordance with the table, it is possible to prevent flickering without significantly making the device structure complicated and increasing costs. Moreover, since ways of non-progressive driving of the scan lines can be changed simply by changing the content of the table, no large change is required in the device structure.

In the organic EL device according to the present aspect, it is preferable that the drive device control whether the scan lines in a frame are driven non-progressively depending on a status of a previous frame.

Since this structure controls whether the scan lines in a frame are driven non-progressively depending on the status of a previous frame, it is possible to apply the present non-progressive driving when flickering is likely in displaying still images and to apply non-progressive driving according to related art when flickering is likely in displaying moving images in a flexible manner.

In the organic EL device according to the present aspect, it is preferable that the drive device drive the scan lines non-progressively so that selection timing of each subframe for adjacent scan lines has no periodicity.

Flickering is likely when selection timing of each subframe for adjacent scan lines has periodicity. Therefore, it is possible to effectively prevent flickering by driving the scan lines non-progressively so that selection timing of each subframe for adjacent scan lines has no periodicity.

A method for driving an organic EL device according to another aspect of the invention is a method for driving an organic EL device including a plurality of scan lines, a plurality of data lines extending in a direction orthogonal to the scan lines, and a light-emitting element arranged at each intersection of the scan lines and the data lines, and includes: dividing one frame into a plurality of subframes in accordance with grayscale levels represented by an image signal supplied to the data lines; controlling light emission of the light-emitting element using the subframe to set a unit; and driving the scan lines non-progressively so that selection timing of each subframe for each scan line has no periodicity.

With this method, the scan lines are driven non-progressively so that selection timing of each subframe for each scan line has no periodicity. It is therefore possible to prevent flickering attributed to periodicity in selecting the scan lines and display quality images as a result.

In the method for driving an organic EL device according to the present aspect, it is preferable that the scan lines be driven non-progressively so that selection timing of each subframe for each scan line has no periodicity at least partly in one frame.

Non-progressive driving does not always cause flickering, but causes flickering depending on displayed images. Therefore, for example, it is possible to apply driving to prevent flickering to a central area of an image where flickering is likely and to apply driving according to related art to other areas in a flexible manner.

In the method for driving an organic EL device according to the present aspect, it is preferable that the scan lines be driven non-progressively in accordance with a table to make selection timing of each subframe for each scan line have no periodicity.

Since this method makes selection timing of each subframe for each scan line have no periodicity in accordance with the table, it is possible to change ways of non-progressive driving of the scan lines simply by changing the content of the table.

In the method for driving an organic EL device according to the present aspect, it is preferable that the scan lines in a frame be driven non-progressively depending on a status of a previous frame.

Since this method controls whether the scan lines in a frame are driven non-progressively depending on the status of a previous frame, it is possible to apply the present non-progressive driving when flickering is likely in displaying still images and to apply non-progressive driving according to related art when flickering is likely in displaying moving images in a flexible manner.

In the method for driving an organic EL device according to the present aspect, it is preferable that the scan lines be driven non-progressively so that selection timing of each subframe for adjacent scan lines has no periodicity.

Flickering is likely when selection timing of each subframe for adjacent scan lines has periodicity. Therefore, it is possible to effectively prevent flickering by driving the scan lines non-progressively so that selection timing of each subframe for adjacent scan lines has no periodicity.

An electronic apparatus according to yet another aspect of the invention includes any organic EL device described above.

This structure provides an electronic apparatus capable of displaying quality images.

### BRIEF DESCRIPTION OF THE DRAWINGS

The invention will be described with reference to the accompanying drawings, wherein like numbers reference like elements.

FIG. 1 is a block diagram showing the electrical structure of an organic EL device according to one embodiment of the invention.

FIG. 2 is a block diagram showing the structure of a display panel unit 3.

FIG. 3 is a circuit diagram showing the structure of a pixel 20 on the upper left corner of a display panel 11.

FIG. 4 is a timing chart showing signals output from a peripheral drive device 2 to the display panel unit 3.

FIG. 5 is a diagram for explaining subframes.

FIG. 6 is a circuit diagram showing the structure of a row selection driver 13.

FIG. 7 is a circuit diagram showing the structure of a data driver 14.

FIG. 8 is a diagram for explaining a method for driving the organic EL device according to the embodiment of the invention.

FIG. 9 shows examples of electronic apparatuses according to another embodiment of the invention.

### DESCRIPTION OF EXEMPLARY EMBODIMENTS

An organic EL device, a method for driving the organic EL device, and an electronic apparatus according to embodiments of the invention will be hereinafter described referring to the accompanying drawings. The embodiments are shown by way of example, and not intended to limit the invention. It is understood that various modifications can be made without departing from the spirit and scope of the invention. It is also noted that the scale of each layer and member is adequately changed in the accompanying drawings, so that they are visible.

Organic EL Device

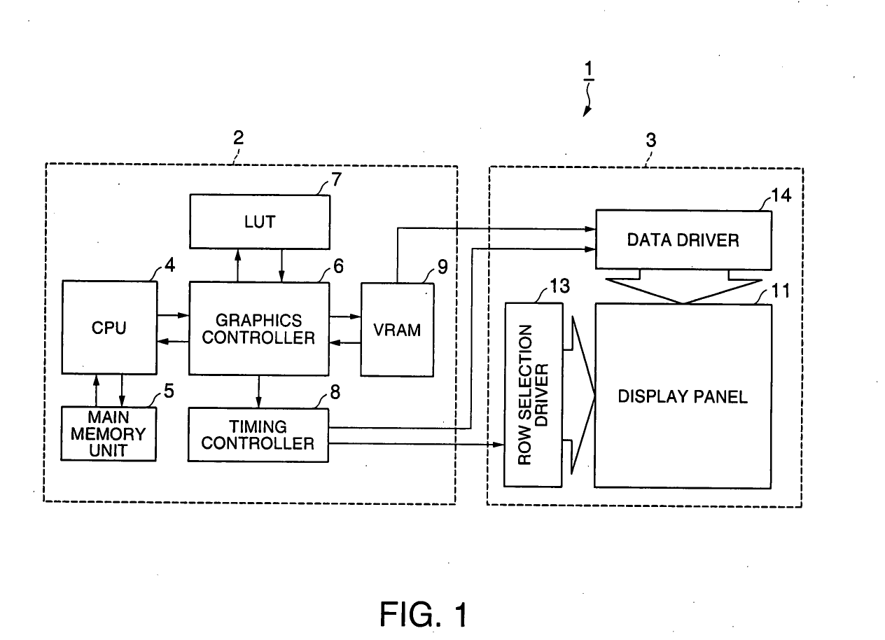

FIG. 1 is a block diagram showing the electrical structure of an organic EL device according to one embodiment of the invention. This organic EL device 1 adopts a time division grayscale scheme that divides a frame into five subframes with different time periods and adequately selects any subframe to emit light to present a halftone.

Referring to FIG. 1, the organic EL device 1 includes a peripheral drive device 2 and a display panel unit 3. The peripheral drive device 2 includes a central processing unit (CPU) 4, a main memory unit 5, a graphics controller 6, a lookup table (LUT) 7, a timing controller 8 and a video RAM (VRAM) 9. The CPU 4 may be replaced with a microprocessor unit (MPU). The display panel unit 3 includes a display panel 11, a row selection driver 13 and a data driver 14.

The CPU included in the peripheral drive device 2 reads image data stored in the main memory unit 5, carries out various types of processing, such as expansion, with the main memory unit 5, and outputs processed data to the graphics controller 6. The graphics controller 6 generates image data and synchronizing signals (vertical synchronizing signal and horizontal synchronizing signal) for the display panel unit 3 based on the image data output from the CPU 4. The graphics controller 6 transfers the generated image data to the VRAM 9 and outputs the generated synchronizing signals to the timing controller 8.

The VRAM 9 outputs the image data output from the graphics controller 6 to the data driver 14 included in the display panel unit 3. The timing controller 8 outputs the horizontal synchronizing signal to the data driver 14 included in the display panel unit 3 and the vertical synchronizing signal to the row selection driver 13 included in the display panel unit 3. The image data from the VRAM 9 and the synchronizing signals (vertical synchronizing signal and horizontal synchronizing signal) from the timing controller 8 are synchronized and output to the display panel 11.

The LUT 7 stores data defining the order of transferring image data. The graphics controller 6 refers to the data stored in the LUT 7 and transfers image data to the VRAM 9 in the order based on the data. Transfer of image data based on the data stored in the LUT 7 will be described in greater detail later.

Display Panel Unit 3

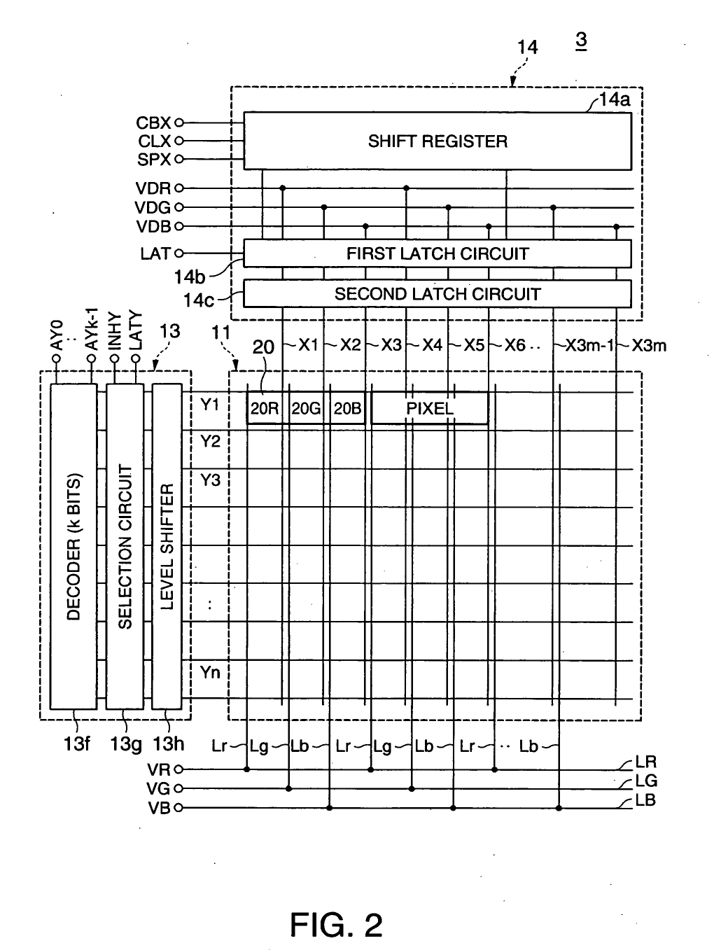

FIG. 2 is a block diagram showing the structure of the display panel unit 3. Referring to the diagram, the display panel 11 included in the display panel unit 3 includes n-number of scan lines Y1 to Yn (n is a natural number) extending in the row direction and 3m-number of data lines X1 to X3m (m is a natural number) extending in the column direction extending in a direction orthogonal to the row direction. The display panel 11 also includes a plurality of pixels-20 at intersections of the scan lines Y1 to Yn and the data lines X1 to X3m. In other words, the pixels 20 are arranged at intersections of the plurality of scan lines Y1 to Yn extending in the row direction and the plurality of data lines X1 to X3m extending in the column direction, and electrically coupled to form a matrix.

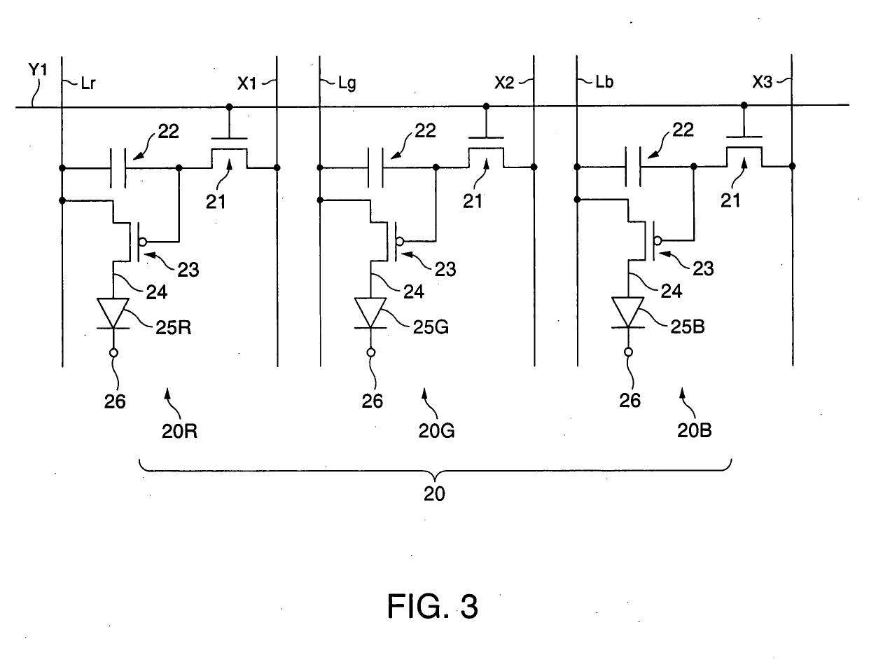

FIG. 3 is a circuit diagram showing the structure of one pixel 20 on the upper left corner of the display panel 11. Referring to the diagram, the pixel 20 on the upper left corner of the display panel 11 includes a subpixel 20R emitting red light from its light-emitting layer, a subpixel 20G emitting green light from its light-emitting layer, and a subpixel 20B emitting blue light from its light-emitting layer. The subpixel 20R includes a switching thin-film transistor (TFT) 21 whose gate electrode receives a scan signal via the scan line Y1, a storage capacitor 22 retaining a pixel signal supplied from the data line X1 via this switching TFT 21, a driving TFT 23 whose gate electrode receives the pixel signal retained by the storage capacitor 22, a pixel electrode (electrode) 24 receiving a driving current from a power line Lr for red when electrically coupled with the line Lr via the driving TFT 23, and an organic EL element 25R sandwiched between the pixel electrode 24 and a common cathode (electrode) 26.

Similarly, the subpixel 20G includes the switching TFT 21 whose gate electrode receives a scan signal via the scan line Y1, the storage capacitor 22 retaining a pixel signal supplied from the data line X2 via this switching TFT 21, the driving TFT 23 whose gate electrode receives the pixel signal retained by the storage capacitor 22, the pixel electrode (electrode) 24 receiving a driving current from a power line Lg for green when electrically coupled with the line Lg via the driving TFT 23, and an organic EL element 25G sandwiched between the pixel electrode 24 and the common cathode (electrode) 26.

Similarly, the subpixel 20B includes the switching TFT 21 whose gate electrode receives a scan signal via the scan line Y1, the storage capacitor 22 retaining a pixel signal supplied from the data line X3 via this switching TFT 21, the driving TFT 23 whose gate electrode receives the pixel signal retained by the storage capacitor 22, the pixel electrode (electrode) 24 receiving a driving current from a power line Lb for blue when electrically coupled with the line Lb via the driving TFT 23, and an organic EL element 25B sandwiched between the pixel electrode 24 and the common cathode (electrode) 26. The other pixels included in the display panel 11 also have the structure made up of the subpixels 20R, 20G, 20B.

With this pixel 20, when the scan line Y1 is driven to turn on the switching TFT 21, the potentials of the data lines X1, X2, X3 at the time are stored in each storage capacitor 22 included in the subpixels 20R, 20G, 20B, respectively. Subsequently, the on/off state of each driving TFT 23 included in the subpixels 20R, 20G, 20B is determined depending on the state of the storage capacitor 22. Then, a current flows to each pixel electrode 24 included in the subpixels 20R, 20G, 20B from the power lines Lr, Lg, Lb, respectively, via a channel in the driving TFT 23, making the current flow into the common cathode 26 via the organic EL elements 25R, 25G, 25B. As a result, the organic EL elements 25R, 25G, 25B emit light depending on the amount of current flow.

Referring back to FIG. 2, the power lines Lr, Lg, Lb are arranged in the column direction, so that they are adjacent to the corresponding subpixels 20R, 20G, 20B, respectively, in the display panel 11. The line Lr receives a driving voltage VR for red via a power supply line LR for red. Similarly, the line Lg receives a driving voltage VG for green via a power supply line LG for green, while the line Lb receives a driving voltage VB for blue via a power supply line LB for green. In the present embodiment as will be described in greater detail later, the scan lines Y1 to Yn are driven by a non-progressive method and one frame is divided into subframes. A subframe for emission is adequately selected so as to display an image of one frame on the display panel 11.

Peripheral Drive Device 2

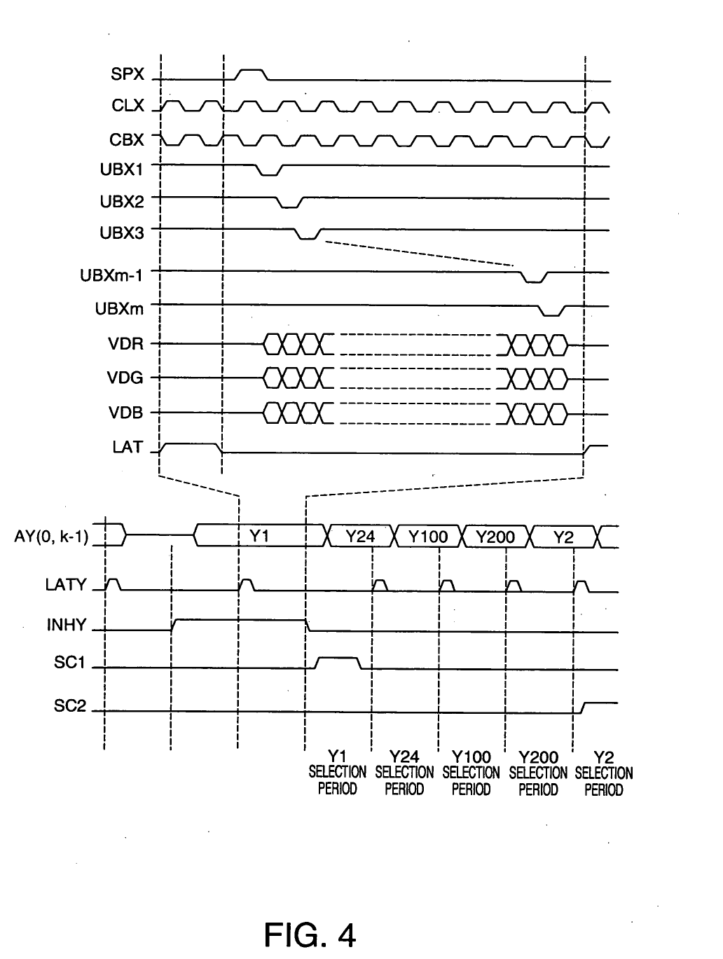

The peripheral drive device 2 will now be described. The peripheral drive device 2 outputs image data and synchronizing signals to the display panel unit 3 in sync with a basic clock signal CLK. FIG. 4 is a timing chart showing signals output from the peripheral drive device 2 to the display panel unit 3. Referring to this chart, the peripheral drive device 2 generates a data driver start pulse SPX, a data driver clock signal CLX and an inverted data driver clock signal CBX, and outputs them to the data driver 14 included in the display panel unit 3.

The data driver start pulse SPX is output each time one of the scan lines Y1 to Yn is selected. The pulse is a signal for selecting one pixel 20 at a time from left to right in FIG. 2 on one selected line out of the lines Y1 to Yn. The data driver clock signal CLX and the inverted data driver clock signal CBX are complementary signals. They are signals for shifting the data driver start pulse SPX sequentially. According to the present embodiment, the pixel 20 is made up of a set of the subpixel 20R for red, the subpixel 20G for green and the subpixel 20B for blue.

The data driver start pulse SPX is shifted in response to the data driver clock signal CLX and the inverted data driver clock signal CBX for each set as a unit, selecting each set of the subpixels 20R, 20G, 20B from left to right in FIG. 2. The peripheral drive device 2 also produces a latch transfer signal LAT based on the basic clock signal CLK and outputs the signal LAT to the data driver 14. The signal LAT is for, at a predetermined timing, holding (latching) digital data signals VDR, VDG, VDB written in one pixel 20 at a time on each selected scan line.

Referring to FIG. 4, the peripheral drive device 2 generates a k-bit (k is a natural number) row selection driver address signals AY0 to AYk-1, a row selection driver output control signal INHY and a row selection driver latch transfer signal LATY, and outputs them to the row selection driver 13 included in the display panel unit 3. The row selection driver address signals AY0 to AYk-1 are for specifying the scan lines Y1 to Yn, respectively. The signals AY0 to AYk-1 are output non-progressively under the control of the graphics controller 6 included in the peripheral drive device 2. The peripheral drive device 2 therefore outputs the digital data signals VDR, VDG, VDB for each pixel 20 on the scan lines Y1 to Yn selected according to the row selection driver address signals AY0 to AYk-1, which are output non-progressively, to the data driver 14.

The row selection driver latch transfer signal LATY is output every time any of the row selection driver address signals AY0 to AYk-1 is input as shown in FIG. 4. The row selection driver output control signal INHY is at the H level only once when selecting the first scan line in each subframe and remains at the L level after that as shown in FIG. 4.

The peripheral drive device 2 produces the digital data signal VDR for red, the digital data signal VDG for green, and the digital data signal VDB for blue of each pixel 20 (20R, 20G, 20B) based on image data stored in the main memory unit 5. The peripheral drive device 2 outputs the produced signals VDR, VDG, VDB to the data driver 14 in sync with the data driver clock signal CLX and the inverted data driver clock signal CBX.

In other words, the peripheral drive device 2 outputs the digital data signals VDR, VDG, VDB of one pixel 20 (20R, 20G, 20B) selected at a time from left to right on each selected line in sync with the data driver clock signal CLX and the inverted data driver clock signal CBX. The digital data signals VDR, VDG, VDB are binary and determine emission of the organic EL elements 25R, 25G, 25B included in each pixel 20. Light is emitted when the signals VDR, VDG, VDB are at the H level, while light is not emitted when the signals VDR, VDG, VDB are at the L level.

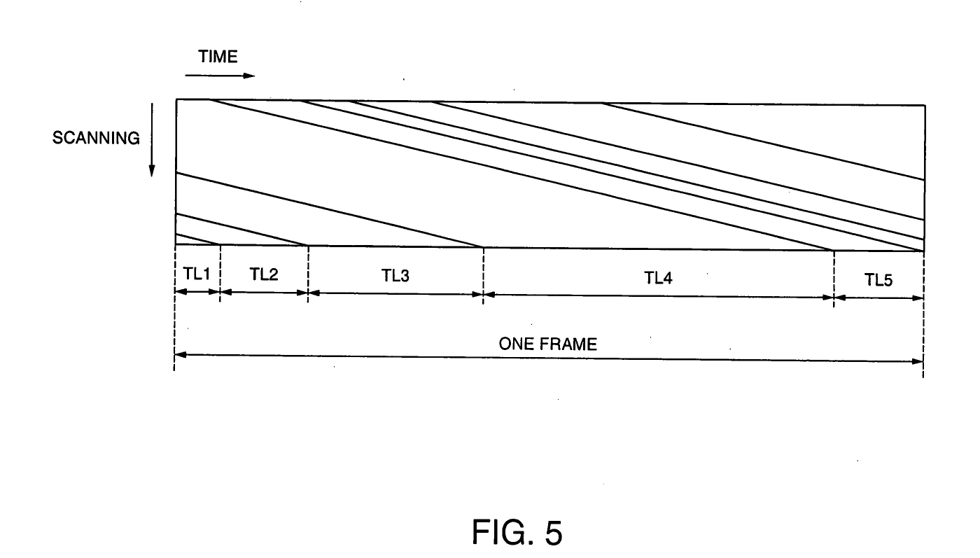

The peripheral drive device 2 represents grayscale by dividing one frame into four subframes with different time periods and an auxiliary subframe, selecting a subframe for emission, and driving the scan lines Y1 to Yn by a non-progressive method. The auxiliary subframe is used so as not to make the organic EL elements 25R, 25G, 25B of each pixel 20 (20R, 20G, 20B) emit light. FIG. 5 is a diagram for explaining subframes.

Referring to the diagram, 16 grayscale levels for image are available by dividing one frame into four subframes, i.e. first to fourth subframes SF1 to SF4, and one auxiliary subframe SF5. Periods TL1 to TL4 for the first to fourth subframes SF1 to SF4, respectively, and another period TL5 for the auxiliary subframe SF5 are set to have the following time ratio: TL1:TL2:TL3:TL4:TL5=1:2:4:8:2. The ratio is given by way of example, and can be set adequately.

If grayscale data D require 15 grayscale levels, all of the first to fourth subframes SF1 to SF4 are selected to emit light for a light-emitting period T (=TL1+TL2+TL3+TL4) to provide the luminance of the 15 grayscale levels. If image data require 6 grayscale levels, only the second subframe SF2 and the third subframe SF3 are selected to emit light for another light-emitting period T (=TL2+TL3), so that the pixel 20 emits light with the luminance of the 6 grayscale levels. This means that supplying the largest data current Imax corresponding to the 15 grayscale levels to the data lines X1 to X3m and changing a light-emitting period T according to the grayscale of image data can make the pixel 20 emit light with the luminance of the grayscale of the image data.

In order to do this, the peripheral drive device 2 produces the digital data signals VDR, VDG, VDB for each of the subframes SF1 to SF4 included in one frame of each pixel 20 based on the image data of this pixel 20. In other words, the peripheral drive device 2 produces the binary digital data signals VDR, VDG, VDB determining emission of the organic EL elements 25R, 25G, 25B during each of the subframes SF1 to SF4. Furthermore, the peripheral drive device 2 transfers the digital data signals VDR, VDG, VDB that have been produced in an order based on the data stored in the LUT 7 for the non-progressive driving.

Row Selection Driver 13

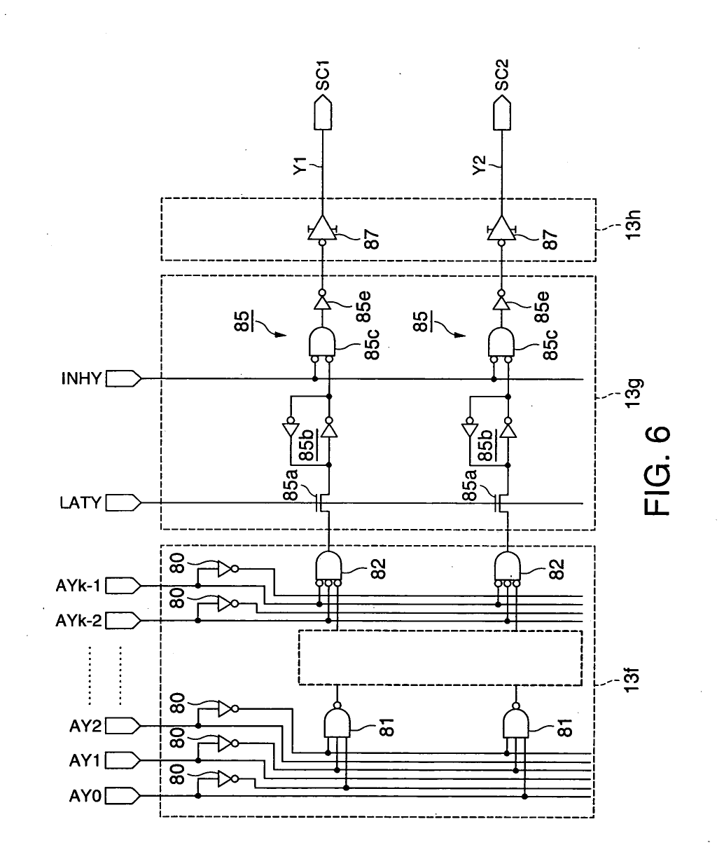

The row selection driver 13 will now be described. FIG. 6 is a circuit diagram showing the structure of the row selection driver 13. Referring to this diagram, the row selection driver 13 receives the row selection driver address signals AY0 to AYk-1, the row selection driver output control signal INHY and the row selection driver latch transfer signal LATY as input signals from the peripheral drive device 2. The row selection driver 13 includes a decoder 13f, a selection circuit 13g and a level shifter 13h.

The decoder 13f includes a plurality of inverter circuits 80, a plurality of NAND circuits 81 and n-number of NOR circuits 82 corresponding to the scan lines Y1 to Yn, and receives the k-bit row selection driver address signals AY0 to AYk-1 as input signals. The decoder 13f specifies a scan line out of the n-number of scan lines Y1 to Yn based on the k-bit row selection driver address signals AY0 to AYk-1 and outputs an H-level output signal from an NOR circuit 82 on the specified scan line. Accordingly, the decoder 13f outputs an H-level output signal from one out of the n-number of NOR circuits 82 to the selection circuit 13g of the next stage every time any of the row selection driver address signals AY0 to AYk-1 is input.

The selection circuit 13g includes n-number of retention circuits 85 corresponding to the scan lines Y1 to Yn. Each of the retention circuits 85 includes a switch 85a, a latch part 85b, NOR circuits 85c, 85d and an inverter circuit 85e. The switch 85a has an NMOS transistor. Coupled between the corresponding NOR circuit 82 and the latch part 85b, the switch 85a latches an output signal from the NOR circuit 82 in the latch part 85b when its gate receives the row selection driver latch transfer signal LATY at the H level.

The row selection driver latch transfer signal LATY at the H level is output every time any of the row selection driver address signals AY0 to AYk-1 is input as shown in FIG. 4. Accordingly, only one corresponding latch part 85b out of all the latch parts 85b included in all the retention circuits 85 latches an H-level output signal, while the other latch parts 85b latch an L-level output signal.

The latch part 85b is made up of two inverter circuits and latches the output signal from the NOR circuit 82. The output signal latched by the latch part 85b is output to the NOR circuit 85c. The NOR circuit 85c has two input terminals one of which receives the output signal latched by the latch part 85b and the other of which receives the row selection driver output control signal INHY. The signal INHY is at the H level only once when selecting the first scan line in each of the subframes SF1 to SF5 and remains at the L level after that as shown in FIG. 4.

Accordingly, when the NOR circuit 85c receives the row selection driver output control signal INHY at the L level and an L-level signal output by the latch part 85b, an L-level signal is output from the inverter circuit 85e of the next stage. Meanwhile, when the NOR circuit 85c receives the row selection driver output control signal INHY at the L level and an H-level signal output by the latch part 85b, an H-level signal is output from the inverter circuit 85e of the next stage. This signal is output to a corresponding scan line out of the scan lines Y1 to Yn as scan signals SC1 to SCn via a buffer circuit 87 included in the level shifter 13h.

With this structure, the scan lines are selected non-progressively from top, for example, the first scan line Y1 to the 24th. scan line Y24, the 100th. scan line Y100, the 200th. scan line Y200 to the second scan line Y2 and so on, during the first subframe SF1 based on the row selection driver address signals AY0 to AYk-1 output from the peripheral drive device 2. Here, the peripheral drive device 2 outputs the digital data signals VDR, VDG, VDB of one pixel 20 at a time to the data driver 14 in the following order: each pixel 20 on the scan line Y1, the 24th. scan line Y24, the 100th. scan line Y100, the 200th. scan line Y200, the second scan line Y2 and so on. Based on the digital data signals VDR, VDG, VDB, each pixel 20 on the selected scan line emits light with a supplied current Ioled according to data currents IDR, IDG, IDB.

Data Driver 14

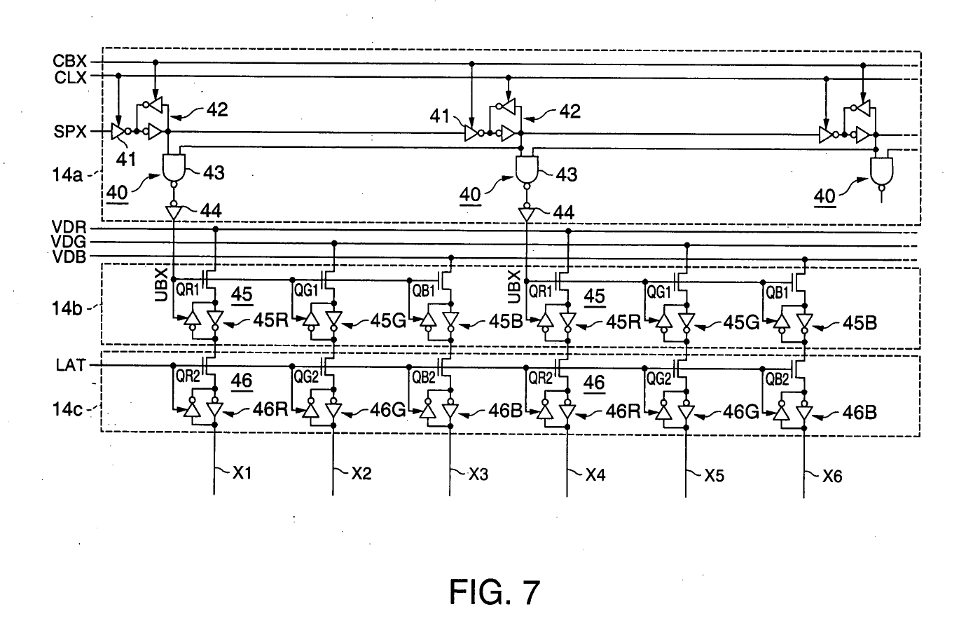

The data driver 14 will now be described. FIG. 7 is a circuit diagram showing the structure of the data driver 14. As shown in the diagram, the data driver 14 receives the data driver start pulse SPX, the data driver clock signal CLX and the inverted data driver clock signal CBX as inputs from the peripheral drive device 2. The data driver 14 also receives the digital data signal VDR, VDG, VDB as inputs from the peripheral drive device 2. The data driver 14 also receives the latch transfer signal LAT as an input from the peripheral drive device 2. The data driver 14 supplies data currents Id1 to Id3m to the data lines X1 to X3m, respectively, to drive the lines X1 to X3m in sync with the selection of the scan lines Y1 to Yn based on these signals.

The data driver 14 includes a shift register 14a, a first latch circuit 14b and a second latch circuit 14c. These components will be described below one by one.

Shift Register 14a

Referring FIG. 7, the shift register 14a includes 3m-number of the data lines X1 to X3m. Here, every three data lines make up a group. The shift register 14a also includes m-number (i.e. the number of data line groups) of retention circuits 40. It is understood that FIG. 7 shows only three of the retention circuits 40 for simplifying the description. Each of the retention circuits 40 includes an inverter circuit 41, a latch part 42, a NAND circuit 43 and an inverter circuit 44.

The inverter circuit 41 included in each retention circuit 40 in odd numbered stages receives the data driver clock signal CLX, while the inverter circuit 41 included in each retention circuit 40 in even-numbered stages receives the inverted data driver clock signal CBX as a synchronizing signal. The inverter circuit 41 of each retention circuit 40 in the odd-numbered stages receives the data driver start pulse SPX in response to the rising of the data driver clock signal CLX and outputs the pulse to the latch part 42. The inverter circuit 41 of each retention circuit 40 in the even-numbered stages receives the data driver start pulse SPX in response to the rising of the inverted data driver clock signal CBX and outputs the pulse to the latch part 42.

The latch part 42 included in each retention circuit 40 is made up of two inverter circuits. The latch part 42 included in each retention circuit 40 in the odd-numbered stages receives the inverted data driver clock signal CBX, while the latch part 42 included in each retention circuit 40 in the even-numbered stages receives the data driver clock signal CLX as a synchronizing signal. The latch part 42 included in each retention circuit 40 in the odd-numbered stages receives the data driver start pulse SPX from the inverter circuit 41 in response to the rising of the inverted data driver clock signal CBX and holds the pulse. The latch part 42 included in each retention circuit 40 in even-numbered stages receives the data driver start pulse SPX from the inverter circuit 41 in response to the rising of the data driver clock signal CLX and holds the pulse. Each latch part 42 outputs the data driver start pulse SPX it holds to the inverter circuit 41 included in the retention circuit 40 of the next stage.

Accordingly, the data driver start pulse SPX at the H level output from the peripheral drive device 2 is sequentially shifted to the retention circuits 40, starting from one corresponding to the three data lines X1 to X3 to one corresponding to the data lines X3m-2 to X3m, in sync with the data driver clock signal CLX and inverted data driver clock signal CBX.

The NAND circuit 43 included in one retention circuit 40 has one input terminal coupled to the output terminal of the latch part 42 and another input terminal coupled to the output terminal of the latch part 42 included in another retention circuit 40 of the next stage. When both the latch parts 42 included in the retention circuit 40 and in the next-stage retention circuit 40 hold the data driver start pulse SPX at the H level, the NAND circuit 43 included in the retention circuit 40 outputs an L-level signal. The NAND circuit 43 outputs an H-level signal when the latch part 42 included in the retention circuit 40 shifts the data driver start pulse SPX. The NAND circuit 43 continues to output an H-level signal until each latch part 42 newly holds the data driver start pulse SPX.

It takes half a period of the data driver clock signal CLX (inverted data driver clock signal CBX) for the signal output from the retention circuit 40 (NAND circuit 43) to rise to the H level after it falls to the L level. The signal from the NAND circuit 43 included in the retention circuit 40 has its level inverted by the inverter circuit 44 and is then output as an inverted output signal UBX to the first latch circuit 14b. FIG. 4 shows the inverted output signal UBX from UBX1, UBX2, UBX3 to UBXm-1 and UBXm based on m-number of the NAND circuits 43 shown in FIG. 7 from left to right.

First Latch Circuit 14b

The first latch circuit 14b receives the inverted output signal UBX sequentially output from the retention circuit 40 included in the shift register 14a. The first latch circuit 14b also receives the digital data signal VDR for the subpixel 20R, the digital data signal VDG for the subpixel 20G, and the digital data signal VDB for the subpixel 20B in sync with the inverted output signal UBX sequentially output from the retention circuit 40.

The first latch circuit 14b includes as many first memory parts 45 as the number of the retention circuits 40. Each of the first memory parts 45 includes three latch parts 45R, 45G, 45B. Each of the first memory parts 45 also includes three switches QR1, QG1, QB1 each of which has an NMOS transistor. Each of the switches QR1, QG1, QB1 has a gate receiving the inverted output signal UBX. The switches are turned on when receiving the inverted output signal UBX at the H level.

The latch part 45R is made up of two inverter circuits and receives the digital data signal VDR via the switch QR1. Similarly, the latch part 45G is made up of two inverter circuits and receives the digital data signal VDG via the switch QG1. Similarly, the latch part 45B is made up of two inverter circuits and receives the digital data signal VDB via the switch QB1.

In response to the inverted output signal UBX at the L level from the corresponding retention circuit 40, the latch parts 45R, 45G, 45B hold the digital data signals VDR, VDG, VDB, respectively, output from the peripheral drive device 2. The first memory parts 45 in the first latch circuit 14b thus store the digital data signals VDR, VDG, VDB in response to the inverted output signal UBX output from the corresponding retention circuits 40 sequentially from left to right in the diagram. The digital data signals VDR, VDG, VDB stored in the first memory parts 45 are output to the second latch circuit 14c.

Second Latch Circuit 14c

The second latch circuit 14c includes as many second memory parts 46 as the number of the first memory parts 45. Each of the second memory parts 46 includes three latch parts 46R, 46G, 46B. Each of the second memory parts 46 also includes three switches QR2, QG2, QB2 each of which has an NMOS transistor. Each of the switches QR2, QG2, QB2 has a gate receiving the latch transfer signal LAT. The switches are turned on when receiving the latch transfer signal LAT at the H level.

The latch part 46R is made up of two inverter circuits and receives the digital data signal VDR held by the latch part 45R of the previous stage via the switch QR2. The latch part 46G is made up of two inverter circuits and receives the digital data signal VDG held by the latch part 45G of the previous stage via the switch QG2. The latch part 46B is made up of two inverter circuits and receives the digital data signal VDB held by the latch part 45B of the previous stage via the switch QB2.

In response to the latch transfer signal LAT at the H level, the latch parts 46R, 46G, 46B in the second memory part 46 hold the digital data signals VDR, VDG, VDB, respectively, output from the latch parts 45R, 45G, 45B, respectively, in the corresponding first memory part 45. This H-level latch transfer signal LAT output to all the second memory parts 46 included in the second latch circuit 14c simultaneously. The digital data signals VDR, VDG, VDB stored in every first memory part 45 in the first latch circuit 14b are stored all at once in the corresponding second memory part 46 in the second latch circuit 14c. The digital data signals VDR, VDG, VDB stored in each second memory part 46 in the second latch circuit 14c are thus output to the data lines X1 to X3m as the data currents Id1 to Id3m.

The operation of the organic EL device 1 with the above-described structure will now be described. The CPU included in the peripheral drive device 2 reads image data stored in the main memory unit 5, carries out various types of processing, such as expansion, with the main memory unit 5, and outputs processed data to the graphics controller 6. When receiving image data of one frame, the graphics controller 6 produces the digital data signals VDR, VDG, VDB for the first to fourth subframes SF1 to SF4 and the auxiliary subframe SF5 for each pixel 20.

As the digital data signals VDR, VDG, VDB for the first to fourth subframes SF1 to SF4 and the auxiliary subframe SF5 included in one frame of each pixel 20 are produced, the graphics controller 6 reads the data stored in the LUT 7 and changes the order of transferring the signals VDR, VDG, VDB. The graphics controller 6 also changes the row selection driver address signals AY0 to AYk-1 as well as the order of transferring the signals VDR, VDG, VDB. Here, the graphics controller 6 changes the order of transferring the signals VDR, VDG, VDB and the row selection driver address signals AY0 to AYk-1 in a way that the selection timing of the first to fourth subframes SF1 to SF4 and the auxiliary subframe SF5 for each of the scan lines Y1 to Yn has no periodicity.

Upon completion of the above-described process, the graphics controller 6 outputs the digital data signals VDR, VDG, VDB, which have been changed in order, to the VRAM 9, and outputs the row selection driver address signals AY0 to AYk-1, which have been changed in order, as well as the synchronizing signals to the timing controller 8. The digital data signals VDR, VDG, VDB are then output to the data driver 14 together with the data driver start pulse SPX, the data driver clock signal CLX, the inverted data driver clock signal CBX and the latch transfer signal LAT. Meanwhile, the row selection driver address signals AY0 to AYk-1 are output to the row selection driver 13 together with the row selection driver output control signal INHY and the row selection driver latch transfer signal LATY, providing a display on the display panel 11.

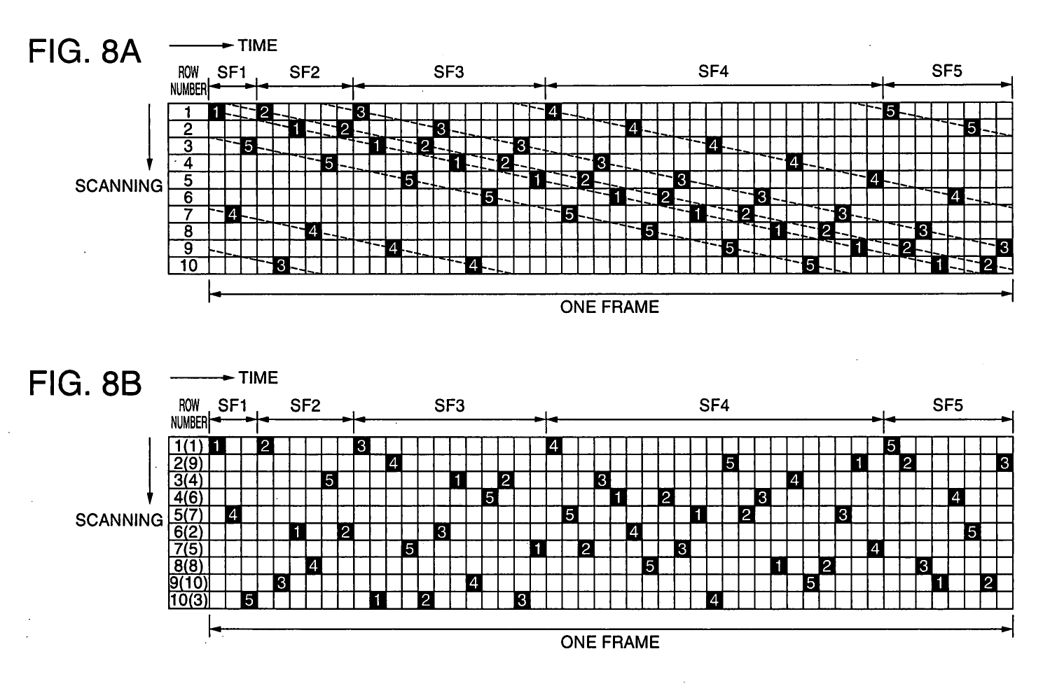

FIG. 8 is a diagram for explaining a method for driving the organic EL device according to the present embodiment. FIG. 8A shows a driving method according to related art, while FIG. 8B shows a driving method of the present embodiment. The numbers 1 through 10 along the vertical direction on the left side of FIG. 8A represent the numbers of the scan lines Y1 to Yn (row numbers). The horizontal direction of the diagram indicates a lapse of time. Referring to the scan line of the row number 1, one frame is divided into the four subframes SF1 to SF4 and one auxiliary subframe SF5.

FIG. 8A shows the lapse of time using one third of the subframe SF1 as a unit for easy understanding. Referring to the scan line of the row number 1 for example, the subframe SF1 is divided into three units and the subframe SF2, which is twice as long as the subframe SF1, is divided into six units in the time direction.

Referring to FIG. 8A, the related art driving method involves a non-progressive method selecting the scan lines number 1, number 7, and then number 3. When driving the scan line number 1, the subframe SF1 is selected. When driving the scan line number 7, the subframe SF4 is selected. When driving the scan line number 3, the auxiliary subframe SF5 is selected.

Subsequently, the scan lines number 1, number 10, number 2, number 8, number 4, and then number 2 are selected non-progressively. When driving the scan line number 1, the subframe SF2 is selected. When driving the scan line number 10, the subframe SF3 is selected. When firstly driving the scan line number 2, the subframe SF1 is selected. When driving the scan line number 8, the subframe SF4 is selected. When driving the scan line number 4, the auxiliary subframe SF5 is selected. When secondly driving the scan line number 2, the subframe SF2 is selected. Non-progressive driving continues as shown in FIG. 8A.

Referring to FIG. 8A, the above-mentioned selection of the scan lines and subframes has periodicity in selecting the subframes in the time direction and the scan lines in the vertical direction of the diagram. This method creates periodicity in the emission timing of the organic EL elements 25R, 25G, 25B in each pixel 20 and may involve flickering depending on images displayed on the organic EL device 1. To address this, the driving method of the present embodiment changes the order of transferring the digital data signals VDR, VDG, VDB and the row selection driver address signals AY0 to AYk-1 in a way that the selection timing of the first to fourth subframes SF1 to SF4 and the auxiliary subframe SF5 for each scan line has no periodicity.

The numbers 1 through 10 on the left side of FIG. 8B similarly to FIG. 8A represent the numbers of the scan lines Y1 to Yn (row numbers). FIG. 8B also shows row numbers in parentheses of the scan lines selecting subframes that are corresponding to the scan lines in FIG. 8A. Referring to the scan line of the row number 1 also in FIG. 8B, one frame is divided into the four subframes SF1 to SF4 and one auxiliary subframe SF5. FIG. 8B also shows the lapse of time using one third of the subframe SF1 as a unit for easy understanding.

Referring to FIG. 8B, the driving method of the present embodiment involves a non-progressive method selecting the scan lines number 1, number 5, and then number 10. When driving the scan line number 1, the subframe SF1 is selected. When driving the scan line number 5, the subframe SF4 is selected. When driving the scan line number 10, the auxiliary subframe SF5 is selected.

Subsequently, the scan lines number 1, number 9, number 6, number 8, number 3, and then number 6 are selected non-progressively. When driving the scan line number 1, the subframe SF2 is selected. When driving the scan line number 9, the subframe SF3 is selected. When firstly driving the scan line number 6, the subframe SF1 is selected. When driving the scan line number 8, the subframe SF4 is selected. When driving the scan line number 3, the auxiliary subframe SF5 is selected. When secondly driving the scan line number 6, the subframe SF2 is selected. Non-progressive driving continues as shown in FIG. 8B.

Referring to FIG. 8B, it is understood that while the order of selecting the scan lines is changed, the order of selecting the subframes is not. In other words, the driving method according to the present embodiment conducts driving equivalent to driving that changes the order of the scan lines adopted in the method shown in FIG. 8A in terms of selection of the scan lines and subframes, so as not to have periodicity in the selecting timing of the subframes for adjacent scan lines. This selection of the scan lines and subframes has no periodicity in the selecting timing of the first to fourth subframes SF1 to SF4 and the auxiliary subframe SF5 for each scan line as shown in FIG. 8B. This method is therefore capable of preventing flickering of displayed images and displaying quality images as a result.

While the order of transferring the digital data signals VDR, VDG, VDB and the row selection driver address signals AY0 to AYk-1 are so changed that the selection timing of the first to fourth subframes SF1 to SF4 and the auxiliary subframe SF5 for each scan line in one frame has no periodicity in the above embodiment, the order in one frame may be partly changed instead.

Since the method according to the present embodiment conducts driving equivalent to driving that changes the order of the scan lines adopted in the method shown in FIG. 8A in terms of selection of the scan lines and subframes, it is possible to drive a central area of an image by the method to prevent flickering and to drive other areas by the related art method in a flexible manner. Changing driving methods can be achieved simply by changing the content of data stored in the LUT 7. It is therefore possible to prevent flickering without significantly making the device structure complicated and increasing costs. Moreover, since ways of non-progressive driving of the scan lines can be changed simply by changing the content of the table, no large change is required in the device structure.

Furthermore, it is possible to control whether the driving method of the present embodiment is applied to one frame depending on the status of the previous frame. In this case, it is possible to adopt the method of the present embodiment when flickering is likely in displaying still images and to adopt the related art method when flickering is likely in displaying moving images in a flexible manner.

While displaying with 16 grayscale levels is described in the above embodiment, the invention is also applicable to displays of 32, 128 and 256 grayscale levels, for example. Moreover, while the organic EL elements 25R, 25G, 25B are used as electro-optical elements in the above embodiment, the invention is also applicable to an inorganic EL element. The invention is thus applicable to an inorganic EL device having such an inorganic EL element. In addition, while the organic EL elements are used as an example in the present embodiment, the invention is not limited to them and also applicable to a liquid crystal element, a digital micromirror device (DMD), a field emission display (FED) and a surface-conductive electron-emitter display (SED), for example.

Electronic Apparatus

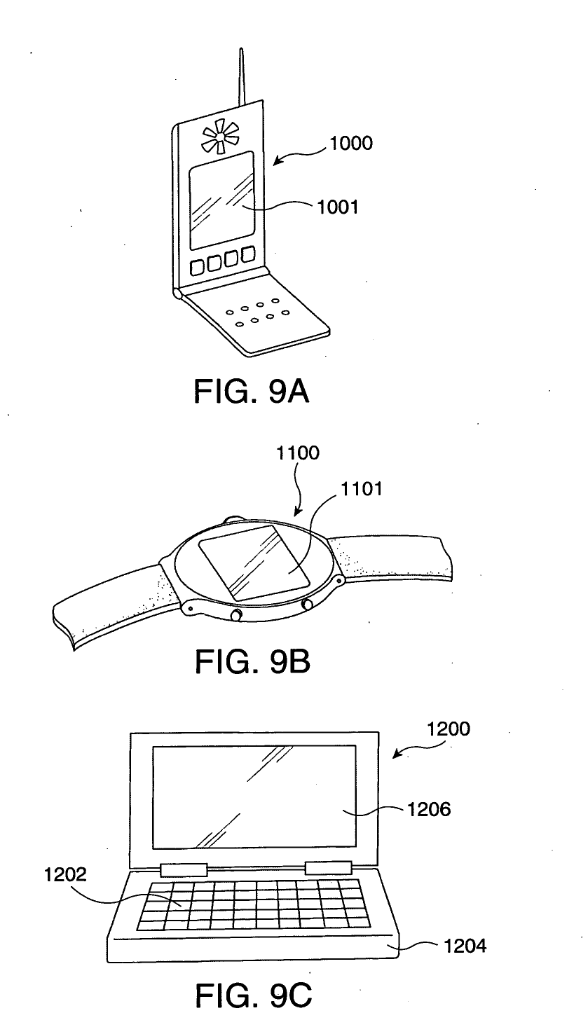

An electronic apparatus according to another embodiment of the invention will now be described. The electronic apparatus of the present embodiment includes the organic EL device 1 as a display and is illustrated by examples shown in FIG. 9. FIG. 9 shows examples of electronic apparatuses according to the present embodiment. FIG. 9A is a perspective view showing an example of cellular phones. Referring to the drawing, this cellular phone 1000 includes a display 1001 using the organic EL device 1. FIG. 9B is a perspective view showing an example of wristwatch type electronic apparatuses. Referring to the drawing, this watch 1100 includes a display 1101 using the organic EL device 1. FIG. 9C is a perspective view showing an example of portable information processors, such as word processors and computers. Referring to the drawing, this information processor 1200 includes an input unit 1202, such as a keyboard, a display 1206 using the organic EL device 1, and an information processor body (case) 1204. The electronic apparatuses shown in FIGS. 9A, 9B and 9C include the displays 1001, 1101 and 1206, respectively, all of which use the organic EL device 1, and thus have a longer life light-emitting element.

The organic EL device 1 of the above embodiment is also applicable to various types of electronic apparatuses, including viewers, game machines and other portable information terminals, electronic books and paper, in addition to the above-described apparatuses. The organic EL device 1 is also applicable to video cameras, digital cameras, car navigation systems, car stereo systems, operation panels, computers, printers, scanners, television sets and video players.

1. An organic electroluminescent device, comprising:
a plurality of scan lines;
a plurality of data lines extending in a direction orthogonal to the scan lines;
a light-emitting element arranged at each intersection of the scan lines and the data lines; and
a drive device dividing one frame into a plurality of subframes in accordance with grayscale levels represented by an image signal supplied to the data lines, controlling light emission of the light-emitting element using the subframe to set a unit, and driving the scan lines non-progressively;
the drive device driving the scan lines non-progressively so that selection timing of each subframe for each scan line has no periodicity.

2. The organic electroluminescent device according to claim 1, the drive device driving the scan lines non-progressively so that selection timing of each subframe for each scan line has no periodicity at least partly in one frame.

3. The organic electroluminescent device according to claim 1, the drive device including a table to make selection timing of each subframe for each scan line have no periodicity and driving the scan lines in accordance with the table.

4. The organic electroluminescent device according to claim 1, the drive device controlling whether the scan lines in a frame are driven non-progressively depending on a status of a previous frame.

5. The organic electroluminescent device according to claim 1, the drive device driving the scan lines non-progressively so that selection timing of each subframe for adjacent scan lines has no periodicity.

6. A method for driving an organic electroluminescent device including a plurality of scan lines, a plurality of data lines extending in a direction orthogonal to the scan lines, and a light-emitting element arranged at each intersection of the scan lines and the data lines, comprising:
dividing one frame into a plurality of subframes in accordance with grayscale levels represented by an image signal supplied to the data lines;
controlling light emission of the light-emitting element using the subframe to set a unit; and
driving the scan lines non-progressively so that selection timing of each subframe for each scan line has no periodicity.

7. The method for driving an organic electroluminescent device according to claim 6, the scan lines being driven non-progressively so that selection timing of each subframe for scan line has no periodicity at least partly in one frame.

8. The method for driving an organic electroluminescent device according to claim 6, the scan lines being driven non-progressively in accordance with a table to make selection timing of each subframe for each scan line have no periodicity.

9. The method for driving an organic electroluminescent device according to claim 6, the scan lines in a frame being driven non-progressively depending on a status of a previous frame.

10. The method for driving an organic electroluminescent device according to claim 6, the scan lines being driven non-progressively so that selection timing of each subframe for adjacent scan lines has no periodicity.

11. An electronic apparatus, comprising:
the organic electroluminescent device according to claim 1.
